(19) United States
(12) Patent Application Publication
(10) Pub. No.: US 2018/0372250 A1
(43) Pub. Date: Dec. 27, 2018

(54) Hose Clamp for Preventing Leaks

(71) Applicant: Thomas Guy Putorti, Staatsburg, NY (US)

(72) Inventor: Thomas Guy Putorti, Staatsburg, NY (US)

(21) Appl. No.: 15/630,738

(22) Filed: Jun. 22, 2017

(51) Int. Cl. F16L 33/02; F16L 3/223; F16L 33/10

(52) U.S. Cl. CPC F16L 33/02; F16L 3/00; F16L 33/10; F16L 3/223

(57) ABSTRACT

A hose clamp to be used with high-pressure hoses consists of a first clamping plate, a second clamping plate, and a fastening mechanism. The first clamping plate and the second clamping plate are positioned around the high-pressure hose and removably attached together with the fastening mechanism. When positioned appropriately, the high-pressure hose is placed within a receiving channel of the first clamping plate and a receiving channel of the second clamping plate. An inner rubber coating is used to further secure the high-pressure hose within the receiving channel of the first clamping plate and the second clamping plate. To do so, the inner rubber coating is layered along the receiving channel of the first clamping plate and the second clamping plate.

### FIELD OF THE INVENTION

The present invention relates generally to hose clamps. More specifically, the present invention is a hose clamp that is to be used with steel braided hoses of various diameters to stop a leak and restore functionality.

### BACKGROUND OF THE INVENTION

High-pressure hoses are used in a variety of fields. In fields such as towing and other comparable fields that use heavy machinery, high-pressure hoses are used along with hydraulic systems. Even though these high-pressure hoses aid in fulfilling many of the duties of the industry, there are certain drawbacks as well. Labor intensive maintenance and the difficulty in containing leaks are some of the major disadvantages

Most of the time, when a leak occurs in a high-pressure hose, it is due to a small hole that allows the fluids travelling through the hose to seep out through the hole. Since the leak is not due to a gashed line or a fully severed line, the user needs to be able to swiftly contain the leak.

With existing high-pressure hose designs, the hose needs to be replaced in its entirety if a leak is to be contained. Thus, the process of containing a leak can be financially disadvantageous to the user in the long term. Additionally, the process of replacing a damaged hose with a new hose can be time consuming. Thus, more labor hours are required.

The objective of the present invention is to address the aforementioned issues. In particular, the present invention eliminates the need to replace a high-pressure hose entirely when a leak occurs. The present invention also significantly reduces the time required to contain a leak.

### BRIEF DESCRIPTION OF THE DRAWINGS

FIG. 1 is a perspective view of the present invention being positioned on a high-pressure hose.

FIG. 2 is an exploded perspective view of the present invention.

FIG. 3 is a perspective view of the first clamping plate.

FIG. 4 is a perspective view of the second clamping plate.

FIG. 5 is a side view of the first clamping plate.

FIG. 6 is a side view of the second clamping plate.

### DETAIL DESCRIPTIONS OF THE INVENTION

All illustrations of the drawings are for the purpose of describing selected versions of the present invention and are not intended to limit the scope of the present invention.

The present invention introduces an apparatus that is used to contain leaks or fix other comparable damages caused to a high-pressure hose. The convenience and effectiveness of the present invention allows the user to utilize minimum amount of labor and replace the damaged hose without replacing the hose entirely.

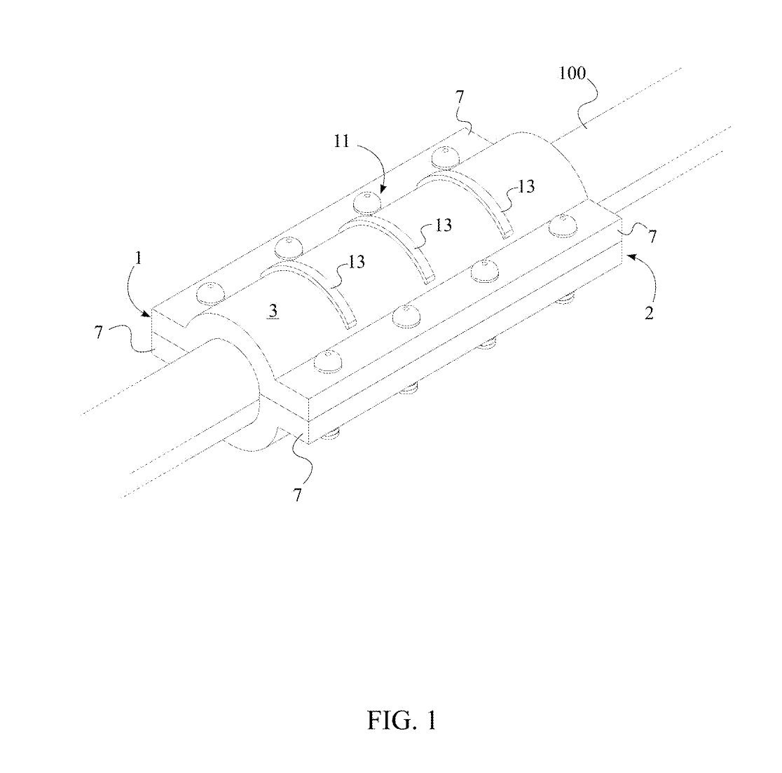

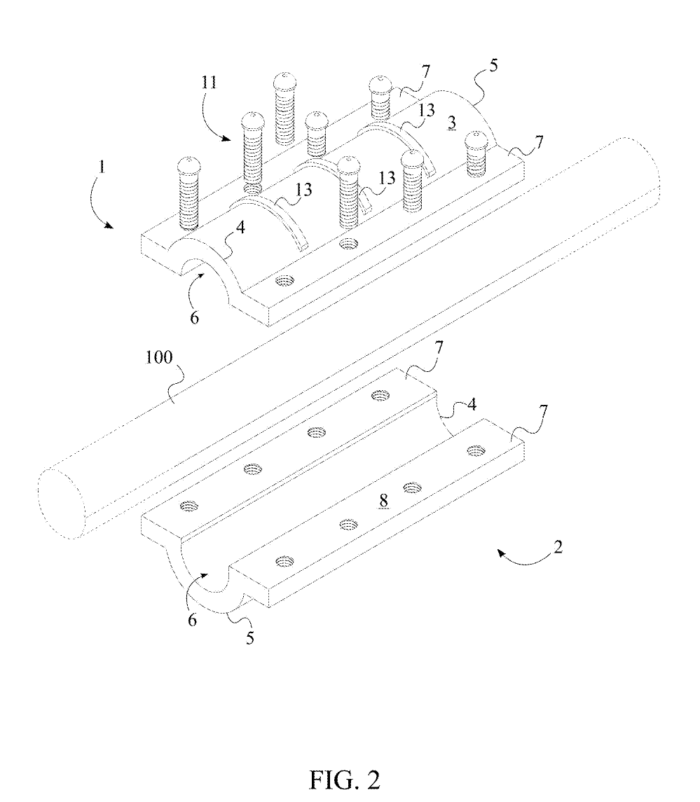

As illustrated in FIG. 1 and FIG. 2, the present invention comprises a first clamping plate 1, a second clamping plate 2, and a fastening mechanism 11. Both the first clamping plate 1 and the second clamping plate 2 are positioned around a high-pressure hose 100 that contains a leak. The first clamping plate 1 and the second clamping plate 2 are kept stationary with the use of the fastening mechanism 11. The fastening mechanism 11 can vary in different embodiments of the present invention.

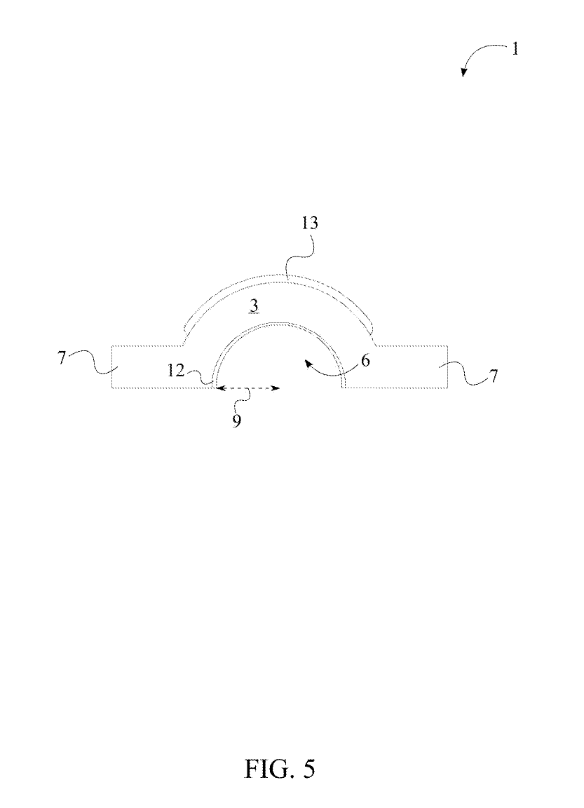

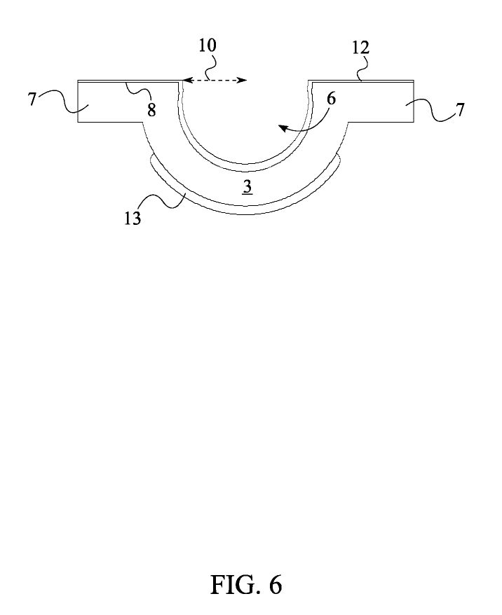

As seen in FIG. 2, to position the high-pressure hose 100 in between the first clamping plate 1 and the second clamping plate 2, the first clamping plate 1 and the second clamping plate 2 each comprise a plate body 3, a receiving channel 6, and a pair of flanges 7. The plate body 3 of the first clamping plate 1 and the second clamping plate 2 provides the structural strength to the present invention. The receiving channel 6 of the first clamping plate 1 and the second clamping plate 2 are used to position the high-pressure hose 100. In particular, the receiving channel 6 is specifically designed so that the high-pressure hose 100 fits tightly within the receiving channel 6 of the first clamping plate 1 and the second clamping plate 2. In different embodiments of the present invention, to accommodate high-pressure hoses of different diameters, a radius 9 of the receiving channel 6 of the first clamping plate 1 can be different from a radius 10 of the receiving channel 6 of the second clamping plate 2. As an example, if a cross-sectional shape of the high-pressure hose 100 is not circular, the radius of the receiving channel 6 is appropriately sized so that the high-pressure hose 100 fits tightly in between the first clamping plate 1 and the second clamping plate 2. In the preferred embodiment of the present invention, the radius 10 of the receiving channel 6 of the second clamping plate 2 is greater than the radius 9 of the receiving channel 6 of the first clamping plate 1 as shown in FIG. 5 and FIG. 6.

As seen in FIG. 1, the pair of flanges 7 of the first clamping plate 1 and the second clamping plate 2 are used to clamp the first clamping plate 1 and the second clamping plate 2 together around the high-pressure hose 100. To do so, the pair of flanges 7 is connected to the plate body 3 laterally opposite each other on the plate body 3 for each of the first clamping plate 1 and the second clamping plate 2. To be positioned around the high-pressure hose 100, the receiving channel 6 traverses into the plate body 3 of the first clamping plate 1 and the second clamping plate 2 from a first end 4 of the plate body 3 to a second end 5 of the plate body 3. A distance between the first end 4 and the second end 5 determines a length of the first clamping plate 1 and the second clamping plate 2. The length of the first clamping plate 1 and the second clamping plate 2 can vary from one embodiment to another.

When positioned around the high-pressure hose 100, the first clamping plate 1 and the second clamping plate 2 are in an assembled configuration. In the assembled configuration, the pair of flanges 7 of the first clamping plate 1 is aligned with the pair of flanges 7 of the second clamping plate 2. Moreover, the pair of flanges 7 of the first clamping plate 1 is positioned atop the pair of flanges 7 of the second clamping plate 2 or vice versa. To be positioned around the high-pressure hose 100, the receiving channel 6 of the first clamping plate 1 is linearly aligned with the receiving channel 6 of the second clamping plate 2 in the assembled configuration. When appropriately positioned, the first clamping plate 1 is removably attached to the second clamping plate 2 with the fastening mechanism 11.

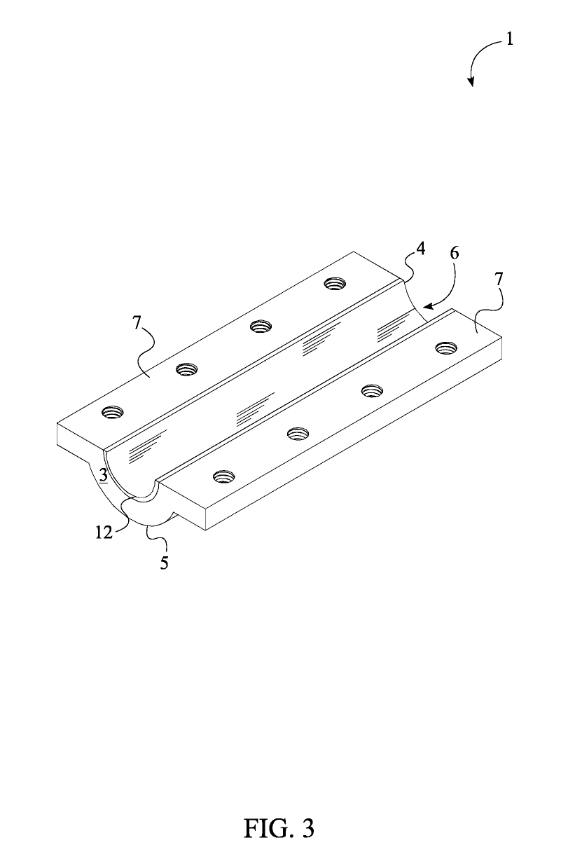

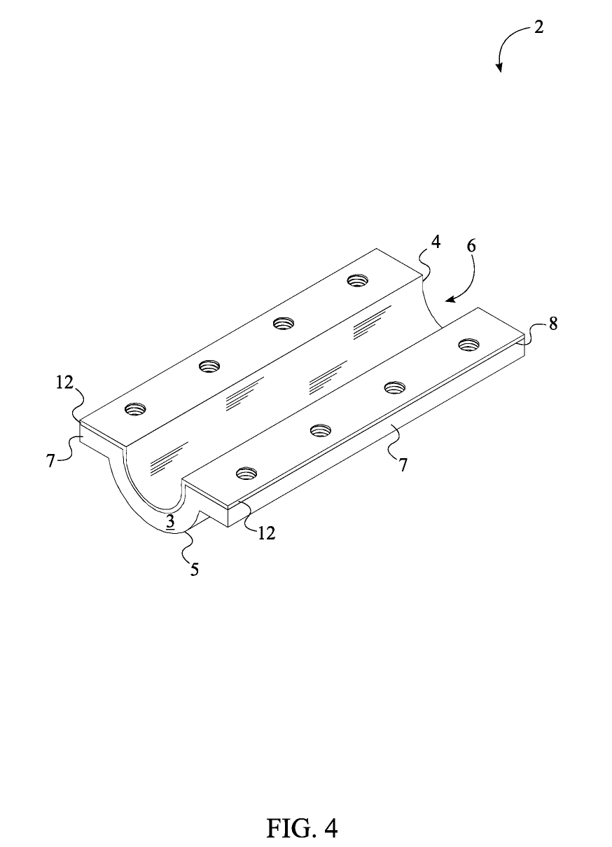

If the receiving channel 6 of the first clamping plate 1 and the second clamping plate 2 are not pressed against the high-pressure hose 100, fluids can continue to seep through an opening between the first clamping plate 1 and the second clamping plate 2. To avoid such circumstances, the present invention further comprises an inner rubber coating 12. As seen in FIG. 3, the inner rubber coating 12 is layered along the receiving channel 6 of the first clamping plate 1 and the second clamping plate 2 from the first end 4 to the second end 5. Moreover, the inner rubber coating 12 is also layered along an inner surface 8 of the pair of flanges 7 of the second clamping plate 2 as shown in FIG. 4. Thus, when the first clamping plate 1 and the second clamping plate 2 are removably attached together, the inner rubber coating 12 removes any air that can be trapped in between the first clamping plate 1 and the second clamping plate 2. Preferably, the inner rubber coating 12 is ribbed so that the inner rubber coating 12 can adjust according to the external surface of the high-pressure hose 100. Since most high-pressure hoses are steel braided, the ability to adjust according to the surface of the high-pressure hose 100 is extremely important.

The present invention further comprises a plurality of ridge protrusions 13 to provide additional structural strength to the first clamping plate 1 and the second clamping plate 2. To do so, the plurality of ridge protrusions 13 is externally distributed along the plate body 3 of the first clamping plate 1 and the second clamping plate 2 opposite the receiving channel 6 as seen in FIG. 1. In addition to providing structural strength, the plurality of ridge protrusions 13 also allows the user to hold the first clamping plate 1 and the second clamping plate 2 firmly when installing the present invention around the high-pressure hose 100.

When the present invention is utilized, the following process flow is generally followed. Initially, the high-pressure hose 100 is positioned within the receiving channel 6 of the first clamping plate 1 and the second clamping plate 2. To do so, the pair of flanges 7 of the first clamping plate 1 is aligned and positioned atop the pair of flanges 7 of the second clamping plate 2. The plurality of ridge protrusions 13 on the first clamping plate 1 and the second clamping plate 2 allows the user to maintain a firm hold while positioning the first clamping plate 1 and the second clamping plate 2. Next, the first clamping plate 1 is attached to the second clamping plate 2 with the fastening mechanism 11. In the preferred embodiment of the present invention, a plurality of bolts and a plurality of bolt receiving holes are used as illustrated in FIG. 2. The plurality of bolt receiving holes traverse through the pair of flanges 7 of the first clamping plate 1 and the second clamping plate 2. To attach the first clamping plate 1 to the second clamping plate 2, a bolt from the plurality of bolts is inserted to a corresponding hole from the plurality of bolt receiving holes for both the first clamping plate 1 and the second clamping plate 2. Thus, the first clamping plate 1 is pressed against the second clamping plate 2. Even though bolts and bolt receiving holes were used in the preferred embodiment of the present invention, different fastening mechanisms can be used in other embodiments of the present invention.

Although the invention has been explained in relation to its preferred embodiment, it is to be understood that many other possible modifications and variations can be made without departing from the spirit and scope of the invention as hereinafter claimed.

What is claimed is:

1. A hose clamp for containing leaks comprises:
a first clamping plate;
a second clamping plate;
a fastening mechanism;
the first plate and the second plate each comprise a plate body, a receiving channel, and a pair of flanges;
the pair of flanges being connected to the plate body laterally opposite each other on the plate body for each of the first clamping plate and the second clamping plate;
the receiving channel traversing into the plate body from a first end of the plate body to a second end of the plate body; and
the pair of flanges of the first clamping plate being removably attached to the pair of flanges of the second clamping plate with the fastening mechanism.

2. The hose clamp for containing leaks as claimed in claim 1 further comprises:
wherein the first clamping plate and the second clamping plate are in an assembled configuration;
the pair of flanges of the first clamping plate being aligned with the pair of flanges of the second clamping plate;
the receiving channel of the first clamping plate being linearly aligned with the receiving channel of the second clamping plate; and
the pair of flanges of the first clamping plate being positioned atop the pair of flanges of the second clamping plate.

3. The hose clamp for containing leaks as claimed in claim 1 further comprises:
an inner rubber coating;
the inner rubber coating being layered along the receiving channel of the first clamping plate and the second clamping plate from the first end to the second end; and
the inner rubber coating being layered along an inner surface of the pair of flanges on the second clamping plate.

4. The hose clamp for containing leaks as claimed in claim 3, wherein the inner rubber coating is ribbed.

5. The hose clamp for containing leaks as claimed in claim 1, wherein a diameter of the second receiving channel is greater than a diameter of the first receiving channel.

6. The hose clamp for containing leaks as claimed in claim 1 further comprises:
a plurality of ridge protrusions; and
the plurality of ridge protrusions being externally distributed along the plate body of the first clamping plate and the second clamping plate opposite to the receiving channel.
